(19) United States
(12) Patent Application Publication
(10) Pub. No.: US 2008/0281688 A1
(43) Pub. Date: Nov. 13, 2008

(54) SYSTEM AND METHOD FOR SHARING REVENUE RESULTING FROM ONLINE COUPON USE

(76) Inventor: Scott E. Kluth, Streamwood, IL (US)

Correspondence Address: MATHEW R. P. PERRONE, JR., 210 SOUTH MAIN STREET, ALGONGUIN, IL, 60102-2639, US

(21) Appl. No.: 11/746,384

(22) Filed: May 9, 2007

(51) Int. Cl. G06Q 40/00; G06Q 30/00

(52) U.S. Cl. 705/14; 705/26; 705/39

(57) ABSTRACT

A coupon revenue sharing system has a main affiliate, at least one partner affiliate and an affiliate reporting network wherein the main affiliate has coupons which it loads onto a coupon file which is loaded onto the coupon database managed by a partner affiliate. The partner affiliate uses the coupon database to create a website displaying the main affiliate coupons. The affiliate reporting network has a tracking server and a commission database to track the use of an online coupon and report transactions utilizing the coupon and paying the main affiliate its share of the commission earned. Moreover, the main affiliate reports the transaction and pays the partner affiliate its portion of the commission.

This invention relates to a system and method for sharing a commission earned through online coupon redemption between a main affiliate and at least one partner affiliate, and more particularly to a system and method for redirecting a query, made by an online shopper, from an affiliate website to a tracking server to a web page of an online merchant and tracking, recording, and sharing the online coupon revenue accordingly.

### BACKGROUND OF THE INVENTION

Online shopping has become an increasingly common method for consumers to make purchases and has become a lucrative outlet for merchants to sell their goods. As a result, online coupons have become a popular way for merchants to lure potential customers to their website, browse their online catalogs, and make purchases. This promotion increases the profits for the online merchant and the savings for the online consumer.

Online coupons are usually available online and thus, many private websites exist which put a variety of coupons from at least one product source, such as a merchant, on at least one page. The online shopping customer can click on a coupon of interest and be redirected to the website for the coupon provider or offer maker, where that person can complete a desired transaction utilizing the coupon. This arrangement benefits all parties in that the customer can readily find and use any online coupons of a desired merchant, thereby saving money on any desired purchases. The online merchant attracts potential customers though this form of advertising. Finally, the private website owner is paid by the online merchant by a commission, flat fee, or any other suitable arrangement to post these coupons on their private website. However, for this system to promote the interests of all of the parties involved, the reporting system must be fair, accurate, and convenient.

In the prior art, there is a system which tracks the use of printable coupons and their in store use through a bar code system and uses the bar code to determine the portion of the commission due to the revenue sharing organization. However, a system in which two or more affiliate websites utilize the coupon database of at least one specific website and track coupon use and share the commission will be a useful improvement in art for both the customer, and the provider and supplier of the goods or services being sought.

### SUMMARY OF THE INVENTION

Among the many objectives of this invention is the provision of a coupon revenue sharing system which is capable of recording and tracking the use of an online coupon from an online customer contact found through browsing or searching on a partner affiliate, through a series of redirects, and finally to an online merchant website.

A further objective of this invention is the provision of a coupon revenue sharing system which is capable of redirecting a customer from a partner website to an affiliate reporting network to a merchant website.

A still further objective of this invention is the provision of a coupon revenue sharing system which provides an affiliate reporting network that contains a tracking server and commission database capable of tracking and recording the use of an online coupon found on a partner website, through a series of redirects, and used on an online merchant website.

Also, a further objective of this invention is the provision of a coupon revenue sharing system which provides an affiliate reporting network that contains a commission database which is capable of accepting reports of transactions from an online merchant database and is capable of reporting the transaction to the main affiliate reporting database.

A still further objective of this invention is the provision of a coupon revenue sharing system which permits sharing of the coupon revenue.

Furthermore, an objective of this invention is the provision of a coupon revenue sharing system, which allows the coupons for the main affiliate to be loaded from its coupon database into its coupon files so that these coupons may be loaded onto the coupon database of the partner affiliate.

A still further objective of this invention is the provision of a coupon revenue sharing system which is efficient and user friendly.

Moreover, a further objective of this invention is the provision of a coupon revenue sharing system which is accurate and convenient for the online merchant, the main affiliate, and the partner affiliate(s).

These and other objectives of the invention (which other objectives become clear by consideration of the specification, claims and drawings as a whole) are met by providing a coupon revenue sharing system which utilizes main affiliate coupons to form a partner website and has a tracking server and a commission database to track the use of an online coupon on a merchant website and report the transaction to the main affiliate.

### BRIEF DESCRIPTION OF THE DRAWINGS

FIG. 1 depicts a block diagram of coupon revenue sharing system 100.

FIG. 2 depicts a flow chart of coupon revenue sharing system 100.

FIG. 3 depicts a flow chart of coupon revenue sharing system 100 which utilizes multiple websites to display main affiliate coupons.

Throughout the figures of the drawings, where the same part appears in more than one figure of the drawings, the same number is applied thereto.

### DESCRIPTION OF THE PREFERRED EMBODIMENTS

The main objective of this invention is to provide a system and a method for a main affiliate to share its coupon database with at least one partner affiliate, and to provide an affiliate reporting network to track and share coupon commissions earned through purchases made on the website of the merchant offering or accepting the coupon. The affiliate reporting network has a tracking server which records the visit to the partner affiliate and redirects the online customer to an online merchant website. Also, the affiliate reporting network has a commission database which is capable of receiving a report of a transaction from the database of a merchant.

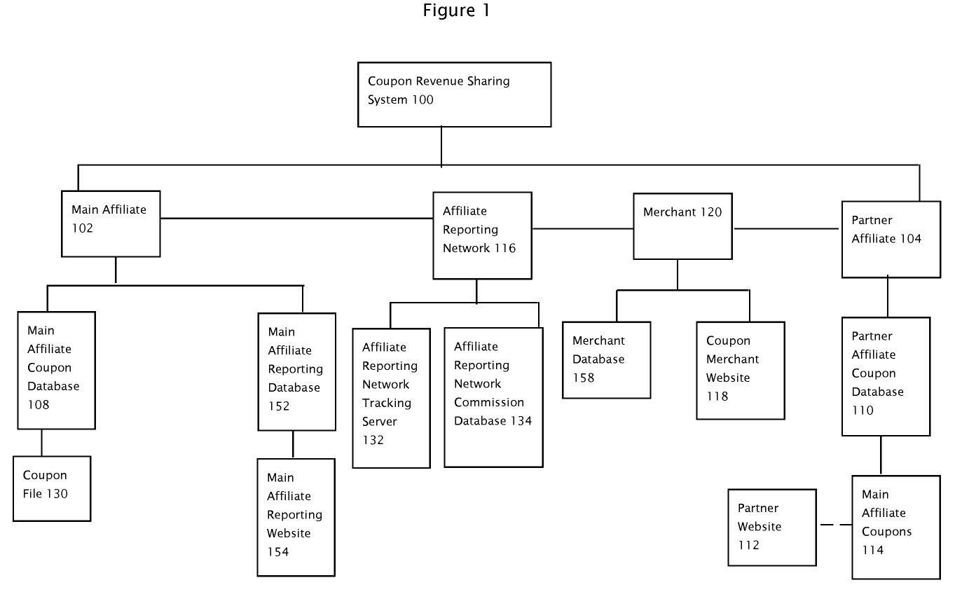

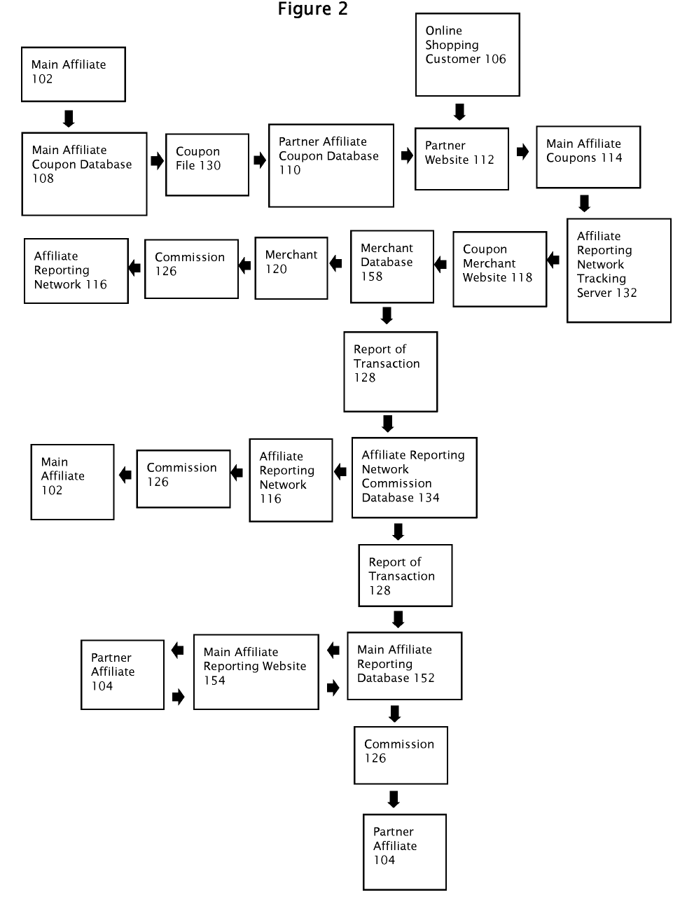

Referring now to FIG. 1 and FIG. 2 jointly, the functionality of coupon revenue sharing system 100 can be seen. Main affiliate 102 manages a main affiliate coupon database 108 having therein coupons and coupon codes to be used by online shopping customers 106. Main affiliate 102 creates a coupon file 130 from main affiliate coupon database 108 and makes it available in multiple formats including but not limited to extensible markup language (XML), comma separated variables (CSV), hypertext markup language (HTML), and rich site summary (RSS), Coupon file 130 has coupons from the main coupon affiliate database 108. Main affiliate 102 loads coupon file 130 onto the partner affiliate coupon database 110 which is managed by partner affiliate 104. Partner affiliate coupon database 110 loads coupon file 130 onto partner website 112 which permits partner website 112 to display main affiliate coupons 114.

An online shopping customer 106 accesses main affiliate coupons 114 through partner website 112. While still on partner website 112, online shopping customer 106 clicks on the link to main affiliate coupons 114.

An affiliate reporting network 116 maintains an affiliate reporting network tracking server 132 and an affiliate reporting network commission database 134. When an online shopping customer 106 clicks on a link to main affiliate coupon 114 on partner website 112, the query is redirected to affiliate reporting network tracking server 132. Tracking server 132 records each customer visit and redirects online shopping customer 106 to the corresponding coupon merchant website 118. Online shopping customer 106 utilizes the coupon 114 and completes the online transaction on coupon merchant website 118 and the report of the transactions 28 is stored on merchant database 158.

Merchant 120 then electronically sends a report of the transaction 128 to the affiliate reporting network 116. Affiliate reporting network 116 stores the report of the transaction 128 on affiliate reporting network commission database 134. Merchant 120 can send the report of the transaction 128 via electronic mail or any other suitable form of electronic transfer. Also, merchants 20 pays affiliate reporting network 116 either a fixed or percentage commission 126 for the sale. The merchant 120 may pay the affiliate reporting network 116 by check, credit card, electronic transfer, or any suitable method of payment.

Then, affiliate reporting network 116 electronically sends a report of the transaction 128 to main affiliate 102. Main affiliate 102 stores the report of the transaction 128 on main affiliate reporting database 152. Affiliate reporting network 116 can send the report of the transaction 128 to main affiliate 102 via electronic mail or any other suitable form of electronic transfer. Affiliate reporting network 116 pays main affiliate either a fixed or percentage commission 126 by check, electronic transfer, credit card, or any other suitable method of payment.

The partner affiliate 104 logs into the main affiliate reporting website 154 to access main affiliate reporting database 152 in order to view its commission 126 earned through the transaction. Main affiliate pays partner affiliate 104 its commission 126 by check, electronic transfer, credit card, or any suitable method of payment.

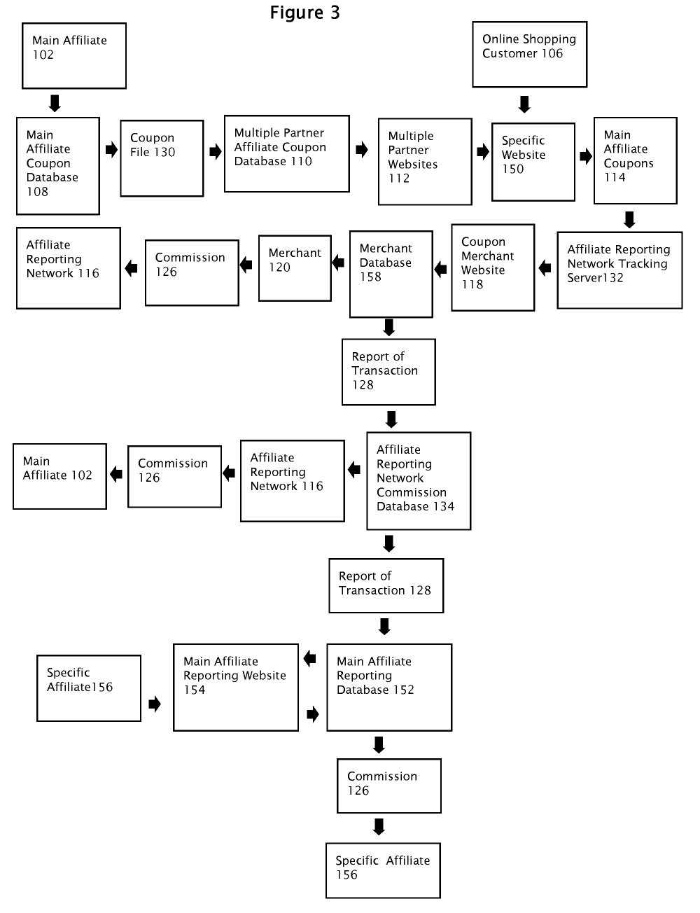

Adding FIG. 3 to the consideration, another variation becomes possible. Coupon revenue sharing system 100 can have a multitude of partner affiliates 104. Main affiliate 102 can load its coupon file 130 onto each of the multitude of partner affiliate coupon databases 110. These multiple partner affiliate coupon databases 110 are used to create multiple partner websites 112 which display main affiliate coupons 114. The single partner website 112 on which online shopping customer 106 clicks on the link to the main affiliate coupon 114 is the specific website 150 which is managed by specific affiliate 156.

An online shopping customer 106 accesses main affiliate coupons 114 through specific website 150. While still on specific website 150, online shopping customer 106 clicks on the link to main affiliate coupons 114.

An affiliate reporting network 116 maintains an affiliate reporting network tracking server 132 and an affiliate reporting network commission database 134. After clicking on the link to main affiliate coupon 114, the online shopping customer 106 is redirected to tracking server 132. Tracking server 132 records the online shopping customer visit and redirects the customer 106 to coupon merchant website 118. The online shopping customer 106 utilizes the coupon 114 and completes the transaction on the coupon merchant website 118 and the report of the transaction 128 is stored on merchant database 158.

Merchant 120 then electronically sends a report of the transaction 128 to the affiliate reporting network 116. Affiliate reporting network 116 stores the report of the transaction 128 on affiliate reporting network commission database 134. Merchant 120 can send the report of the transaction 128 via electronic mail or any other suitable form of electronic transfer. Merchant 120 pays affiliate reporting network 116 either a fixed or percentage commission 126 for the sale. The merchant 120 may pay the affiliate reporting network 116 by check, credit card, electronic transfer, or any other suitable form of payment.

Then, affiliate reporting network 116 electronically sends a report of the transaction 128 to main affiliate 102. Main affiliate 102 stores the report of the transaction 128 onto a main affiliate reporting database 152. Affiliate reporting network 116 can send the report of the transaction 128 via electronic mail or any other suitable form of electronic transfer.

Specific affiliate 156 logs into main affiliate reporting website 154 to view its commission earned. Main affiliate pays specific affiliate 156 the commission by check, electronic transfer, credit card, or any suitable method of payment.

This application—taken as a whole with the abstract, specification, claims, and drawings being combined—provides sufficient information for a person having ordinary skill in the art to practice the invention as disclosed and claimed herein. Any measures necessary to practice this invention are well within the skill of a person having ordinary skill in this art after that person has made a careful study of this disclosure.

Because of this disclosure and solely because of this disclosure, modification of this method and device can become clear to a person having ordinary skill in this particular art. Such modifications are clearly covered by this disclosure.

What is claimed and sought to be protected by Letters Patent of the United States is:

1. A coupon revenue sharing system for sharing between affiliates a commission earned through use of at least one online coupon at a website of at least one merchant comprising:
(a) the coupon revenue sharing system having a main affiliate with a at least one partner affiliate cooperating therewith;
(b) the main affiliate having a main affiliate coupon database with at least one main affiliate coupon;
(c) the main affiliate being able to create a coupon file which contains the at least one main affiliate coupon and is available in at least one format;
(d) the at least one partner affiliate having at least one partner affiliate coupon database onto which the coupon file is loaded;
(e) the at least one partner affiliate coupon database being used to create at least one additional partner website; and
(f) the at least one additional partner website being capable of displaying the at least one main affiliate coupon.

2. The coupon revenue sharing system of claim 1 further comprising:
(a) the at least one additional partner website being capable of redirecting an online shopping customer to a tracking server when the online shopping customer clicks on the at least one main affiliate coupon displayed on the at least one partner website;
(b) the tracking server being capable of recording a visit and redirecting the online shopping customer to at least one coupon merchant website;
(c) a merchant database being capable of storing a report of a transaction; and
(d) a commission database being capable of accepting the report of the transaction from the merchant database.

3. The coupon revenue sharing system of claim 2 further comprising:
(a) the main affiliate having a main affiliate reporting database and at least one main affiliate reporting website;
(b) the main affiliate reporting database being capable of accepting the report of the transaction from the commission database;
(c) the at least one partner affiliate being able to access the main affiliate reporting database through the at least one main affiliate reporting website; and
(d) the main affiliate being capable of paying the at least one partner affiliate its share of the commission earned.

4. The coupon revenue sharing system of claim 3 further comprising the at least one partner affiliate being capable of accessing the main affiliate reporting database by logging into the at least one main affiliate reporting website.

5. The coupon revenue sharing system of claim 4 further comprising the tracking server and commission database being part of a single affiliate reporting network.

6. The coupon revenue sharing system of claim 5 further comprising:
(a) at least one merchant being capable of electronically sending the report of the transaction to the commission database;
(b) the at least one merchant being capable of paying the commission earned to the affiliate reporting network;
(c) the affiliate reporting network being capable of electronically sending the report of the transaction to the main affiliate reporting database; and
(d) the affiliate reporting network being capable of paying the commission earned to the main affiliate.

7. A method of sharing revenue between affiliates which is earned through the use of online coupons at a website of at least one merchant utilizing a coupon revenue sharing system comprising:
(a) providing a main affiliate with a main affiliate coupon database which contains at least one main affiliate coupon;
(b) having the main affiliate create a coupon file which contains the at least one main affiliate coupon and is available in at least one format;
(c) providing a partner affiliate or a plurality of partner affiliates having at least one partner affiliate coupon database;
(d) loading the coupon file into the at least one partner affiliate coupon database;
(e) using the at least one partner affiliate coupon database to make at least one partner website; and
(f) providing the at least one partner website with the capability of displaying main affiliate coupons.

8. The method of claim 7 further comprising:
(a) creating the at least on partner website which is capable of redirecting an online shopping customer to a tracking server when the online shopping customer clicks on the at least one main affiliate coupon displayed on the at least one partner website;
(b) providing the tracking server which is capable of recording the visit and redirecting the online shopping customer to at least one coupon merchant website;
(c) providing a merchant database which is capable of storing a report of a transaction completed on the at least one coupon merchant website;
(d) providing a commission database which is capable of accepting a report of a transaction from a merchant database; and
(e) providing a main affiliate reporting database which is capable of accepting the report of the transaction from the commission database.

9. The method of claim 8 further comprising:
(a) providing a main affiliate reporting website which allows access to the main affiliate reporting database; and
(b) providing the at least one partner affiliate which are capable of logging into the main affiliate reporting website and accessing the main affiliate reporting database.

10. The method of claim 9 further comprising providing an affiliate reporting network which has the tracking server and the commission database.

11. The method of claim 10 further comprising:
(a) providing at least one merchant which is capable of paying the commission earned to the affiliate reporting network;
(b) providing the at least one merchant which is capable of electronically sending the report of the transaction to the affiliate reporting network;
(c) providing the affiliate reporting network which is capable of paying the commission earned to the main affiliate; and
(d) providing the affiliate reporting network which is capable of electronically sending the report of the transaction to the main affiliate.
